(19) United States
(12) Patent Application Publication
(10) Pub. No.: US 2024/0282538 A1
(43) Pub. Date: Aug. 22, 2024

(54) DOUBLE THROW RELAY

(71) Applicant: TE Connectivity Solutions GmbH, Schaffhausen (CH)

(72) Inventors: Dana Hansen, Fairview, NC (US); Shashi Kumara M., Karnataka (IN); Daniel Mohan, Karnataka (IN); Kerry McBride, Fletcher, NC (US)

(21) Appl. No.: 18/169,916

(22) Filed: Feb. 16, 2023

(51) Int. Cl. H01H 50/54; H01H 50/02; H01H 50/18; H01H 50/44

(52) U.S. Cl. CPC H01H 50/54; H01H 50/02; H01H 50/18; H01H 50/44

(57) ABSTRACT

A relay includes fixed contacts in a cavity of a housing including an input contact and first and second output contacts. The relay includes a relay actuator in the cavity having a plunger movable in a linear actuation direction between a retracted position and an advanced position. The relay includes a movable contact coupled to the plunger and movable with the plunger between first and second mated positions. The movable contact is electrically connected to the input contact in both the first mated position and the second mated position. The movable contact is electrically connected to the first output contact and is disconnected from the second output contact in the first mated position. The movable contact is electrically connected to the second output contact and is disconnected from the first output contact in the second mated position.

### BACKGROUND OF THE INVENTION

The subject matter herein relates generally to relays.

Certain electrical applications, such as HVAC, power supply, locomotives, elevator control, motor control, aerospace applications, hybrid electric vehicles, fuel-cell vehicles, charging systems, and the like, utilize electrical relays having contacts that are normally open (or separated). The contacts are closed (or joined) to supply power to a particular device. When the relay receives an electrical signal, the relay is energized to introduce a magnetic field to drive a movable contact to mate with fixed contacts. Power is transferred through the electrical relay when the movable contact is closed. In some applications multiple relays are needed to control different circuits. Providing multiple relays increases the cost and weight of the system, which may be undesirable. Some known systems are double throw relays forming two circuits in a single relay, where one of the circuits is closed when the relay is energized and the other circuit is closed when the relay is deenergized. Such double throw relays use a rotary contact that is rotated when the relay is energized/de-energized to pivot between the various contacts. Such relays are complicated and bulky.

A need exists for a relay that overcomes the above problems and addresses other concerns experienced in the prior art.

### BRIEF DESCRIPTION OF THE INVENTION

In one embodiment, a relay is provided and includes a housing having a wall defining a cavity. The relay includes fixed contacts in the cavity. The fixed contacts include an input contact, a first output contact, and a second output contact. The relay includes a relay actuator in the cavity. The relay actuator includes a plunger movable in a linear actuation direction between a retracted position and an advanced position. The relay includes a movable contact coupled to the plunger and movable with the plunger between a first mated position corresponding to the retracted position and a second mated position corresponding to the advanced position. The movable contact is electrically connected to the input contact in both the first mated position and the second mated position. The movable contact is electrically connected to the first output contact and is disconnected from the second output contact in the first mated position. The movable contact is electrically connected to the second output contact and is disconnected from the first output contact in the second mated position.

In another embodiment, a relay is provided and includes a housing having a wall defining a cavity. The relay includes fixed contacts in the cavity. The fixed contacts include an input contact, a first output contact, and a second output contact. The relay includes a relay actuator in the cavity. The relay actuator includes a plunger movable in a linear actuation direction between a retracted position and an advanced position. The relay includes a movable contact coupled to the plunger and movable with the plunger between a first mated position corresponding to the retracted position and a second mated position corresponding to the advanced position. The movable contact has a first contact portion, a second contact portion, and a third contact portion. The first contact portion is electrically connected to the first output contact in the first mated position. The second contact portion is electrically connected to the second output contact in the second mated position. The third contact portion is electrically connected to the input contact in both the first mated position and the second mated position.

In a further embodiment, a relay is provided and includes a housing having a wall defining a cavity. The housing extends between a first side and a second side. The relay includes right side fixed contacts in the cavity proximate to the right side. The right side fixed contacts include a right side input contact, a first right side output contact, and a second right side output contact. The relay includes left side fixed contacts in the cavity proximate to the left side. The left side fixed contacts include a left side input contact, a first left side output contact, and a second left side output contact. The relay includes a relay actuator in the cavity. The relay actuator includes a plunger movable in a linear actuation direction between a retracted position and an advanced position. The relay includes a movable contact assembly coupled to the plunger and movable with the plunger between a first mated position corresponding to the retracted position and a second mated position corresponding to the advanced position. The movable contact assembly includes a contact holder having a base coupled to the plunger, a right side mounting arm at a right side of the contact holder, and a left side mounting arm at a left side of the contact holder. The movable contact assembly includes a right side movable contact coupled to the right side mounting arm and a left side movable contact coupled to the left side mounting arm. The right side movable contact is electrically connected to the right side input contact in both the first mated position and the second mated position. The right side movable contact is electrically connected to the first right side output contact and is disconnected from the second right side output contact in the first mated position. The right side movable contact is electrically connected to the second right side output contact and is disconnected from the first right side output contact in the second mated position. The left side movable contact is electrically connected to the left side input contact in both the first mated position and the second mated position. The left side movable contact is electrically connected to the first left side output contact and is disconnected from the second left side output contact in the first mated position. The left side movable contact is electrically connected to the second left side output contact and is disconnected from the first left side output contact in the second mated position.

### BRIEF DESCRIPTION OF THE DRAWINGS

FIG. 1 is a perspective view of a relay in accordance with an exemplary embodiment.

FIG. 2 is an enlarged view of a portion of the relay in accordance with an exemplary embodiment.

FIG. 3 is a perspective view of the mating portion of the first output contact in accordance with an exemplary embodiment.

FIG. 4 is a perspective view of the mating portion of the second output contact in accordance with an exemplary embodiment.

FIG. 5 is an exploded view of a portion of the relay showing the plunger and the movable contact assembly in accordance with an exemplary embodiment.

FIG. 6 is a cross-sectional view of the relay in accordance with an exemplary embodiment showing the movable contact assembly in the first mated position.

FIG. 7 is a cross-sectional view of the relay in accordance with an exemplary embodiment showing the movable contact assembly in the second mated position.

### DETAILED DESCRIPTION OF THE INVENTION

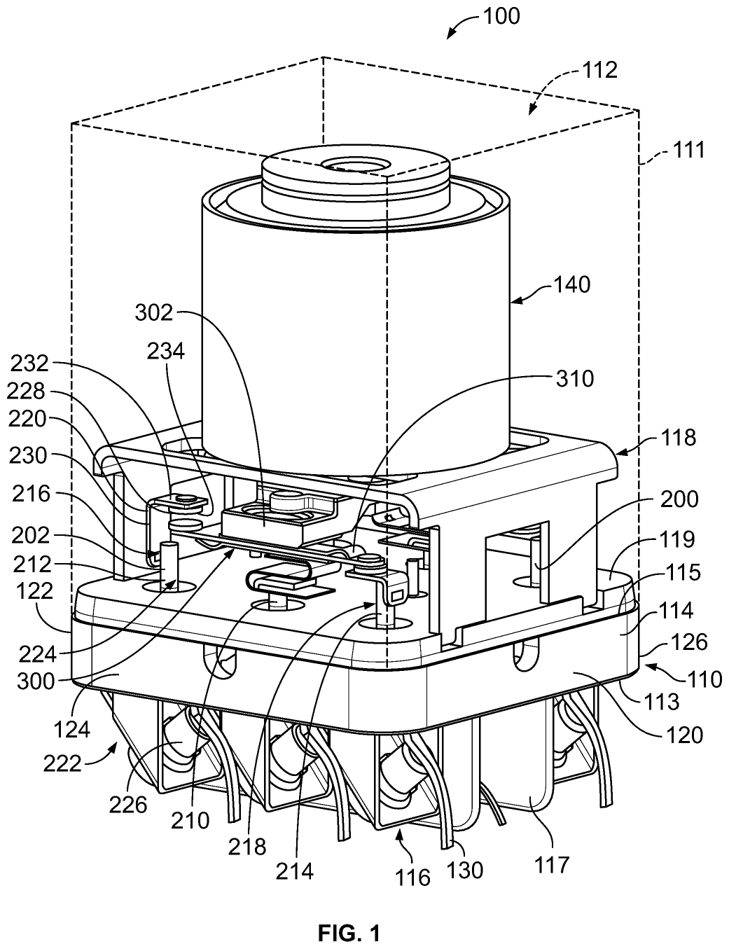

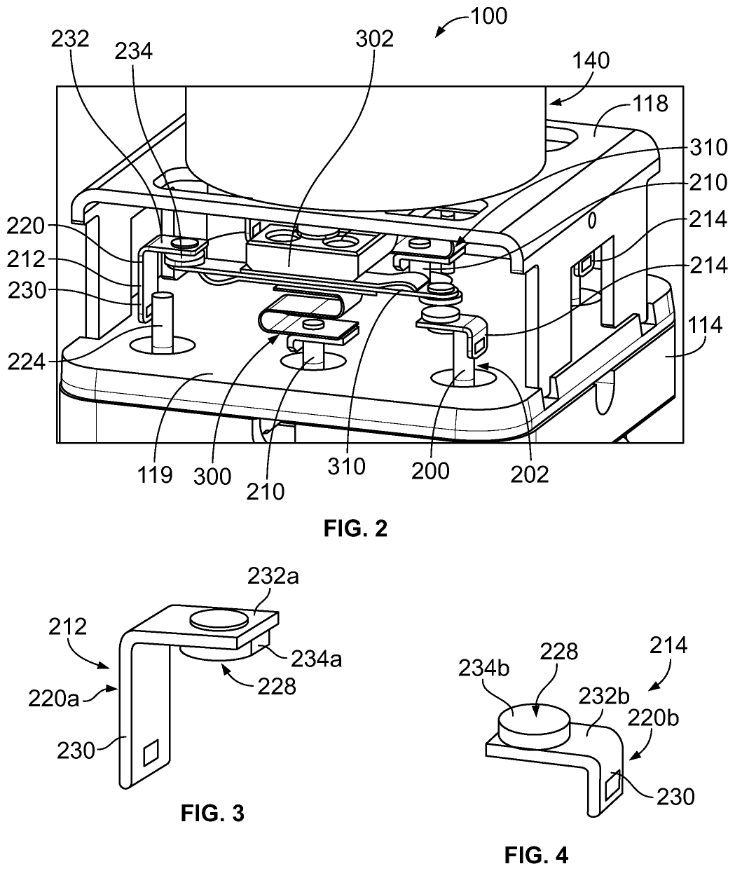

FIG. 1 is a perspective view of a relay 100 in accordance with an exemplary embodiment. FIG. 2 is an enlarged view of a portion of the relay 100 in accordance with an exemplary embodiment. The relay 100 is an electrical switch, such as a contactor, that safely connects and disconnects multiple electrical circuits to protect the flow of power through the system. In an exemplary embodiment, the relay 100 is a double throw relay having two outputs per each input. In an exemplary embodiment, the relay 100 is a double pole-double throw relay having two double throw contact sets in the single relay 100. In an exemplary embodiment, the relay 100 uses linear actuation to achieve the double throw configuration. The relay 100 may be used in various applications such as HVAC, power supply, locomotives, elevator control, motor control, aerospace applications, hybrid electric vehicles, fuel-cell vehicles, charging systems, and the like.

The relay 100 includes a housing 110, a relay actuator 140, fixed contacts 200 forming various circuits of the relay 100, and a movable contact assembly 300 operably coupled to the relay actuator 140 to move between different mated positions to open and close different circuits. The housing 110 encloses the relay actuator 140, the fixed contacts 200 and the movable contact assembly 300. In various embodiments, the relay actuator 140 is a coil assembly and may be referred to hereinafter as a coil assembly 140.

The housing 110 includes an outer wall 111 (shown in phantom to show internal components) surrounding a cavity 112. The housing 110 includes a base 114, wire supports 116 for supporting wires 130, and a coil support 118 for supporting the coil assembly 140. The outer wall 111 may extend from the base 114 and/or surround the base 114. Optionally, the base 114 may be configured to be coupled to another component. For example, the base 114 may include mounting brackets (not shown) for securing the relay 100 to another component.

In various embodiments, the base 114 is manufactured from a dielectric material, such as a plastic material. The base 114 may be a molded plastic part. The base 114 includes a bottom 113 and a top 115. In various embodiments, the housing 110 includes a cover 119 coupled to the top 115 and/or the bottom 113. Optionally, the cover 119 may be sealed to the base 114. In the illustrated embodiment, the wire supports 116 extend from the bottom 113 to locate the wires below the base 114 and the coil support 118 extends from the top 115 to locate the coil assembly above the base 114. Other orientations are possible in alternative embodiments. The base 114 may include separating walls 117 at the bottom 113 to separate or isolate various wire supports 116 from each other, such as to isolate different circuits from each other. The base 114 may be rectangular, such as having four sides. In an exemplary embodiment, the base 114 includes a front 120, a rear 122, a right side 124, and left side 126. The base 114 may have other shapes in alternative embodiments, such as being circular.

The coil support 118 extends from the top 115 of the base 114. The coil support 118 holds the coil assembly at a spaced apart location from the base 114, such as to form a contact space for the contacts of the relay 100. In the illustrated embodiment, the coil support 118 is a stamped and formed part having side walls and a main panel between the side walls. The coil support 118 may have other walls or panels in alternative embodiments. In the illustrated embodiment, the coil support 118 is separate and discrete from the base 114 and coupled thereto. However, in alternative embodiments, the coil support 118 is integral with the base 114, such as being co-molded with the base 114.

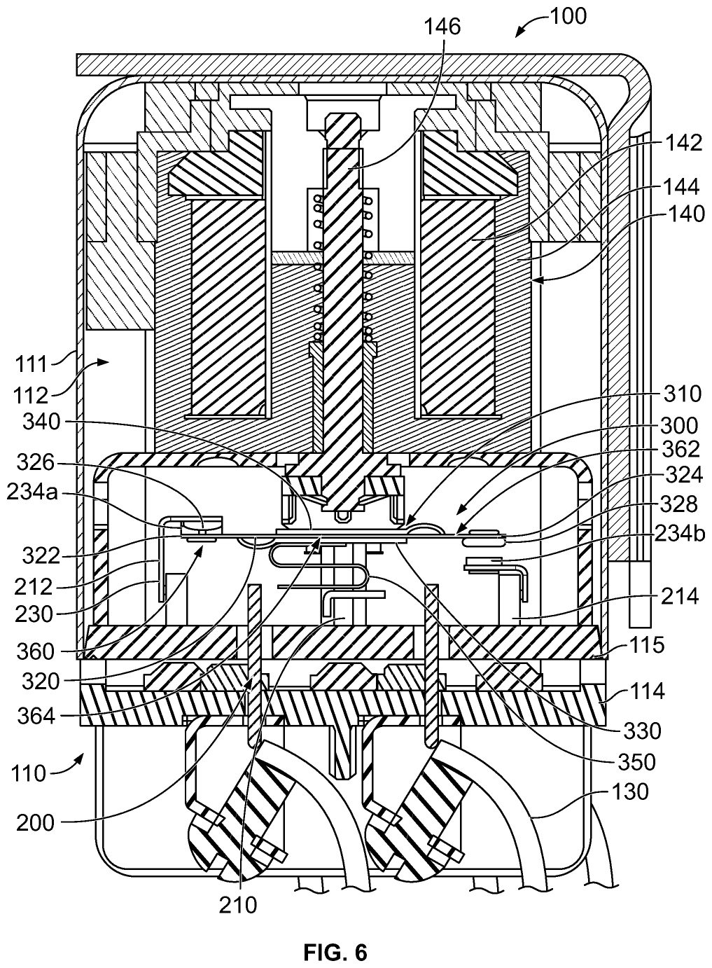

The relay actuator 140 is operated to move the movable contact assembly 300 to open/close the various circuits. In an exemplary embodiment, the relay actuator 140 is a coil assembly. The coil assembly 140 includes a winding or coil 142 (shown in FIG. 6) wound around a core 144 (shown in FIG. 6) to form an electromagnet. The coil assembly 140 includes a plunger 146 coupled to the core 144. The movable contact assembly 300 is coupled to the plunger 146 and is movable with the plunger 146 when the coil assembly 140 is operated. The coil 142 may be energized and deenergized by operation of a control circuit of the coil assembly 140. The coil assembly 140 moves the plunger 146 and the movable contact assembly 300 in an actuation direction, such as in a linear actuation direction, between a retracted position and an advanced position. Optionally, the linear actuation direction may be a vertical direction, such as with the retracted position at a top of the movement and the advanced position at a bottom of the movement. In various embodiments, the retracted position is associated with the deenergized state and the advanced position is associated with the energized state. For example, when the coil assembly 140 is energized, the plunger 146 and the movable contact assembly 300 are moved from the retracted position to the advanced position. The coil assembly 140 may include a return spring (not shown) for returning the plunger 146 and the movable contact assembly 300 to the retracted position when the coil assembly 140 is deenergized.

The relay 100 includes the fixed contacts 200 and the movable contact assembly 300 in the cavity 112, such as in the contact space between the base 114 and the coil assembly 140. The movable contact assembly 300 is movable within the cavity 112 by the plunger 146 between a first mated position and a second mated position. The movable contact assembly 300 is connected to normally closed fixed contacts in the first mated position and is connected to normally open fixed contacts in the second mated position.

The movable contact assembly 300 includes a contact holder 302 coupled to the plunger 146 and at least one movable contact 310 held by the contact holder 302. The contact holder 302 is movable with the plunger 146 between the retracted position and the advanced position. The contact holder 302 moves the movable contacts 310 between the retracted position and the advanced position to move the movable contacts 310 from the first mated position to the second mated position.

The fixed contacts 200 are coupled to the base 114. The fixed contacts 200 protrude from the top 115. The fixed contacts 200 are arranged in the cavity 112 to interface with the movable contact 310. The fixed contacts 200 form circuits when connected to the movable contact 310. The fixed contacts 200 are electrically connected to corresponding wires 130 at the wire supports 116.

In an exemplary embodiment, the fixed contacts 200 are multi-piece contacts. For example, the pieces of the fixed contacts 200 may be welded or otherwise connected together. In the illustrated embodiment, each fixed contact 200 includes a mating portion 220, a terminating portion 222, and a connecting portion 224 between the mating portion 220 and the connecting portion 224. The connecting portion 224 may be a pin, wire, stamped contact, blade contact, spring beam contact, or other type of conductor. The terminating portion 222 is provided at the wire support 116. The terminating portion 222 may be a screw terminal or weld pad for connection to the wire 130. For example, a screw 226 is connected to the terminating portion 222 to connect the wire 130 to the terminating portion 222. The screw 226 may be threadably coupled to the terminating portion 222. The connecting portion 224 may be welded or otherwise connected to the terminating portion 222. The terminating portion 222 may be a stamped and formed part. The mating portion 220 is located in the contact space for connection to the movable contact 310. The mating portion 220 includes a mating interface 228 for mating with the movable contact 310. In various embodiments, the mating portion 220 is a stamped and formed part. The mating portion 220 may be L-shaped having a vertical portion 230 and a horizontal portion 232. The vertical portion 230 extends from the connecting portion 224. The vertical portion 230 may be welded to the connecting portion 224. The horizontal portion 232 forms the mating interface 228. The mating interface 228 may be defined by a contact button or contact tab 234 that is brazed or otherwise provided at the end of the mating portion 220.

In an exemplary embodiment, the fixed contacts 200 are arranged in contact sets 202. Optionally, multiple contact sets 202 are provided to provide a multi-pole relay 100, such as a dual pole relay. For example, the contact sets 202 may be located proximate to the right side 124 and the left side 126. Each contact set 202 includes an input contact 210, a first output contact 212, and a second output contact 214. The input contact 210 may be located between the first and second output contacts 212, 214, such as approximately centered between the front 120 and the rear 122. The first output contact 212 defines a normally closed contact 216. The second output contact 214 defines a normally open contact 218. In various embodiments, the mating interfaces for the first and second output contacts 212 may be located at different vertical heights above the top 115 to interface with the movable contact 310 at different vertical positions (for example, retracted position and advanced position).

The movable contact 310 is electrically connected to the input contact 210 in both the first mated position and the second mated position. The movable contact 310 is electrically connected to the first output contact 212 (normally closed contact 216), and disconnected from the second output contact 214, in the first mated position (retracted position). The movable contact 310 is electrically connected to the second output contact 214 (normally open contact 218), and disconnected from the first output contact 212 in the second mated position (advanced position).

FIG. 3 is a perspective view of the mating portion 220a of the first output contact 212. FIG. 4 is a perspective view of the mating portion 220b of the second output contact 214. The mating portions 220a, 220b are shaped differently. For example, the mating portion 220a is taller and the mating portion 220b is shorter to locate the mating interfaces 228 at different vertical positions for mating with the movable contact 310 (FIG. 2) at different positions. The vertical portions 230 have different heights to locate the mating interfaces 228 at different locations.

In the illustrated embodiment, the contact tab 234a of the mating portion 220a is located at the bottom of the horizontal portion 232a. The contact tab 234a is downward facing. In the illustrated embodiment, the contact tab 234b of the mating portion 220b is located at the top of the horizontal portion 232b. The contact tab 234b is upward facing.

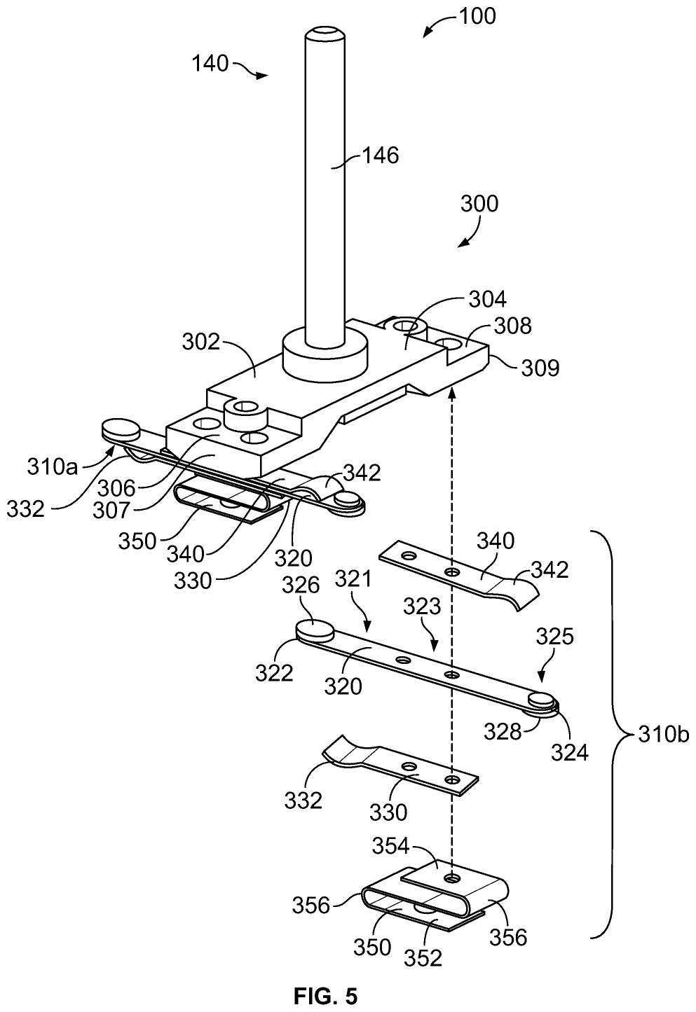

FIG. 5 is an exploded view of a portion of the relay 100 showing the plunger 146 and the movable contact assembly 300 in accordance with an exemplary embodiment. The movable contact assembly 300 is coupled to a distal end of the plunger 146. The plunger 146 is configured to move the movable contact assembly 300 in a linear actuation direction along an axis of the plunger 146.

In an exemplary embodiment, the relay 100 is a double pole double throw relay having a pair of the movable contact 310 each closing different circuits. In the illustrated embodiment, the movable contact assembly 300 includes a first or right side movable contact 310a and a second or left side movable contact 310b. The movable contact 310a, 310b may be identical to each other and have the same components. FIG. 5 illustrates the left side movable contact 310b exploded and poised for coupling to the contact holder 302.

The contact holder 302 includes a contact holder base 304, a right side mounting arm 306 at a right side 307 of the contact holder 302, and a left side mounting arm 308 at a left side 309 of the contact holder 302. The contact holder base 304 is coupled to the plunger 146. The right side movable contact 310a is coupled to the right side mounting arm 306. The left side movable contact 310b is configured to be coupled to the left side mounting arm 308. In an exemplary embodiment, the contact holder 302 is manufactured from a dielectric material, such as a plastic material, to electrically isolate the movable contact 310a, 310b from each other. The contact holder 302 may be a molded part.

Each movable contact 310 includes a contact plate 320, a first backup blade 330, a second backup blade 340, and a flex member 350, which may be held together by fasteners or welds. The backup blades 330, 340 and the flex member 350 are configured to be coupled to the contact plate 320. The flex member 350 is configured to be connected to the input contact 210 (FIG. 2). The flex member 350 is flexible to move with the contact plate 320 as the contact plate 320 is moved up and down by the contact holder 302 between the first mated position and the second mated position. In an exemplary embodiment, the contact plate 320 is oriented perpendicular to the linear movement direction of the movable contact 310.

The contact plate 320 extends between a first end 322 and a second end 324. The contact plate 320 includes a central portion 323 between the first and second ends 322, 324. The flex member 350 is coupled to the contact plate 320 at the central portion 323. Optionally, the backup blades 330, 340 may be coupled to the contact plate 320 at the central portion 323.

The contact plate 320 includes a first contact portion 321 between the central portion 323 and the first end 322. The movable contact 310 includes a first contact tab 326 along the first contact portion 321, such as proximate to the first end 322. The first contact tab 326 defines a first mating interface for the movable contact 310 configured to be electrically connected to the first output contact 212 in the first mated position. In the illustrated embodiment, the first contact tab 326 is upward facing, such as to interface with the downward facing contact tab 234a (shown in FIG. 3) of the first output contact 212. The first backup blade 330 extends along the first contact portion 321. In an exemplary embodiment, the first backup blade 330 includes a support beam 332 for supporting the first contact portion 321. The support beam 332 supports the contact plate 320, such as to prevent downward bending of the first contact portion 321. The support beam 332 may press upward against the first contact portion 321, such as to hold the first contact tab 326 in contact with the contact tab 234a of the first output contact 212. In the illustrated embodiment, the support beam 332 is curved, such as being initially curved away from the contact plate 320 and having the distal end curved back toward the contact plate 320 to engage the contact plate 320.

The contact plate 320 includes a second contact portion 325 between the central portion 323 and the second end 324. The movable contact 310 includes a second contact tab 328 along the second contact portion 325, such as proximate to the second end 324. The second contact tab 328 defines a second mating interface for the movable contact 310 configured to be electrically connected to the second output contact 214 in the second mated position. In the illustrated embodiment, the second contact tab 328 is downward facing, such as to interface with the upward facing contact tab 234b (shown in FIG. 4) of the second output contact 214. The second backup blade 340 extends along the second contact portion 325. In an exemplary embodiment, the second backup blade 340 includes a support beam 342 for supporting the second contact portion 325. The support beam 342 supports the contact plate 320, such as to prevent upward bending of the second contact portion 325. The support beam 342 may press downward against the second contact portion 325 to hold the second contact tab 328 in contact with the contact tab 234b of the second output contact 214. In the illustrated embodiment, the support beam 342 is curved, such as being initially curved away from the contact plate 320 and having the distal end curved back toward the contact plate 320 to engage the contact plate 320. The contact plate 320 may be rigidly held between the first and second backup blades 330, 340, such as to retain the generally planar orientation of the contact plate 320.

The flex member 350 is flexible and movable with the contact plate 320. The flex member 350 extends between a first mating portion 352 and a second mating portion 354. The first mating portion 352 is configured to be coupled to the central portion 323 of the contact plate 320. The second mating portion 354 is configured to be coupled to the input contact 210 (FIG. 2). In various embodiments, the flex member 350 is a stamped and formed contact formed to have at least one bend 356. In the illustrated embodiment, the flex member 350 is folded over twice to include two bends 356. For example, the flex member 350 may be S-shaped. The flex member 350 may form a spring configured to press upward, or pull downward, on the contact plate 320. For example, the flex member 350 may be used to hold the movable contact assembly 300 in the first mated position (normally closed) when the coil assembly 140 is deenergized.

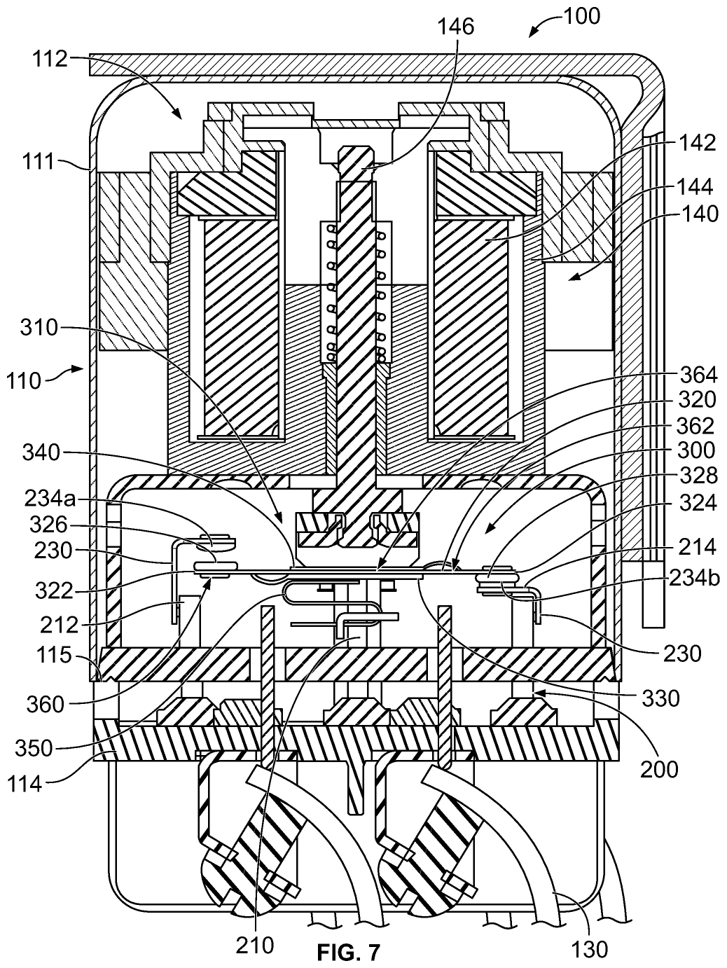

FIG. 6 is a cross-sectional view of the relay 100 in accordance with an exemplary embodiment showing the movable contact assembly 300 in the first mated position. FIG. 7 is a cross-sectional view of the relay 100 in accordance with an exemplary embodiment showing the movable contact assembly 300 in the second mated position. The relay 100 is a double throw relay having the movable contact assembly 300 forming a first circuit in the retracted position (FIG. 6) and a second circuit in the advanced position (FIG. 7). The double throw of the relay is accomplished with a linear actuation of the movable contact assembly 300.

The relay 100 includes the housing 110 having the wall 111 defining the cavity 112. The relay actuator 140 is arranged in the cavity 112. The plunger 146 of the relay actuator 140 is movable in a linear actuation direction between the retracted position (FIG. 6) and the advanced position (FIG. 7). For example, the coil assembly is energized to move the plunger 146 downward from the retracted position to the advanced position. In an exemplary embodiment, the plunger 146 is moved vertically (up and down) in the linear actuation direction. The movable contact assembly 300 is coupled to the plunger 146 and movable with the plunger 146 between the first mated position (FIG. 6) corresponding to the retracted position and the second mated position (FIG. 7) corresponding to the advanced position.

The fixed contacts 200 are arranged in the cavity 112. The fixed contacts 200 include the input contact 210, the first output contact 212, and the second output contact 214. The movable contact 310 is electrically connected to the input contact 210 in both the first mated position and the second mated position. The movable contact 310 is electrically connected to the first output contact 212 and disconnected from the second output contact 214 in the first mated position. The movable contact 310 is electrically connected to the second output contact 214 and disconnected from the first output contact 212 in the second mated position. The input contact 210 and the first output contact 212 create a first circuit in the retracted position/first mated position. The input contact 210 and the second output contact 214 create a second circuit in the advanced position/second mated position.

The contact plate 320 is oriented horizontally, such as perpendicular to the linear actuation direction. The contact plate 320 remains in the horizontal orientation as the movable contact 310 is moved between the first and second mated positions. In an exemplary embodiment, the movable contact 310 has a first contact portion 360, a second contact portion 362, and a third contact portion 364. In the illustrated embodiment, the third contact portion 364 is located between the first and second contact portions 360, 362. The first contact portion 360 is electrically connected to the first output contact 212 in the first mated position. The second contact portion 362 is electrically connected to the second output contact 214 in the second mated position. The third contact portion 364 is electrically connected to the input contact 310 in both the first mated position and the second mated position. For example, the third contact portion 364 is electrically connected to the input contact 310 by the flex member 350. The flex member 350 is flexible to move with the contact plate 320 of the movable contact 310 between the first mated position and the second mated position.

In an exemplary embodiment, the movable contact 310 includes the first contact tab 326 at the first end 322 of the contact plate 320 and the second contact tab 328 at the second end 324 of the contact plate 320. The first contact tab 326 is configured to engage the first contact tab 234a of the first output contact 212 in the first mated position. The second contact tab 328 is configured to engage the second contact tab 234b of the second output contact 214 in the second mated position. In the illustrated embodiment, the first contact tab 326 is upward facing and the second contact tab 328 is downward facing. The first contact tab 234a of the first output contact 212 is downward facing to face the movable contact 310. The second contact tab 234b of the second output contact 214 is upward facing to face the movable contact 310. The first output contact 212 is located above the contact plate 320 and the second output contact 214 is located below the contact plate 320. The movable contact 310 is movable vertically between the first mated position and the second mated position to interface with the first output contact 212 and the second output contact 214, respectively.

In an exemplary embodiment, the first and second backup blades 330, 340 are coupled to the contact plate 320, such as along lower and upper surfaces of the contact plate 320. The first backup blade 330 extends toward the first end 322 to support the first end 322. The second backup blade 340 extends toward the second end 324 to support the second end 324.

In an exemplary embodiment, the housing 110 includes the base 114 at the contact space. The coil assembly 140 is located above the base 114. However, other orientations are possible in alternative embodiments, such as below the base 114 with the wires 130 extending from the top of the relay 100. The fixed contacts 200 extend from the base 114, such as from the top 115. The plunger 146 and the movable contact 310 are movable relative to the base 114 in the linear actuation direction. The contact plate 320 may be oriented parallel to the base 114 and maintain the parallel orientation in both the first mated position and the second mated position. In an exemplary embodiment, the first output contact 212 has a first interface at a first distance from the base 114 and the second output contact 214 has a second interface at a second distance from the base 114. The second distance is different than the first distance. For example, the first interface of the first output contact 212 may be located further from the base 114 and the second interface of the second output contact 214 may be located closer to the base 114. The vertical portions 230 of the output contacts 212, 214 have different heights to position the contact tabs 234a, 234b at different vertical positions relative to the base 114.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A relay comprising:
a housing having a wall defining a cavity;
fixed contacts in the cavity, the fixed contacts include an input contact, a first output contact, and a second output contact;
a relay actuator in the cavity, the relay actuator including a plunger movable in a linear actuation direction between a retracted position and an advanced position;
a movable contact coupled to the plunger and movable with the plunger between a first mated position corresponding to the retracted position and a second mated position corresponding to the advanced position, the movable contact being electrically connected to the input contact in both the first mated position and the second mated position, the movable contact being electrically connected to the first output contact and being disconnected from the second output contact in the first mated position, the movable contact being electrically connected to the second output contact and being disconnected from the first output contact in the second mated position.

2. The relay of claim 1, wherein the input contact and the first output contact create a first circuit in the retracted position and wherein the input contact and the second output contact create a second circuit in the advanced position.

3. The relay of claim 1, wherein the movable contact includes a flex member connected to the input contact, the flex member being flexible to move with the movable contact between the first mated position and the second mated position.

4. The relay of claim 1, wherein the plunger is moved vertically in the linear actuation direction.

5. The relay of claim 1, wherein the movable contact includes a contact plate extending between a first end and a second end, the movable contact including a first contact tab at the first end configured to engage the first output contact in the first mated position, the movable contact including a second contact tab at the second end configured to engage the second output contact in the second mated position.

6. The relay of claim 5, wherein the first contact tab is upward facing and the second contact tab is downward facing.

7. The relay of claim 5, wherein the first output contact is located above the contact plate and the second output contact is located below the contact plate, the movable contact movable vertically between the first mated position and the second mated position to interface with the first output contact and the second output contact, respectively.

8. The relay of claim 5, wherein the movable contact includes a flex member coupled to a central portion of the contact plate, the flex member being flexible to move with the contact plate as the contact plate is moved between the first and second mated positions.

9. The relay of claim 5, wherein the movable contact includes a first backup blade coupled to the contact plate and extending toward the first end to support the first end, the movable contact including a second backup blade coupled to the contact plate and extending toward the second end to support the second end.

10. The relay of claim 5, wherein the contact plate is oriented perpendicular to the linear actuation direction.

11. The relay of claim 1, wherein the housing includes a base, the fixed contacts extending from the base, the plunger and the movable contact being movable relative to the base in the linear actuation direction.

12. The relay of claim 11, wherein the first output contact has a first interface at a first distance from the base and the second output contact has a second interface at a second distance from the base, the second distance being different than the first distance.

13. The relay of claim 1, wherein the relay actuator includes a coil wound around a magnetic core, the coil being energized to move from the retracted position to the advanced position.

14. A relay comprising:
a housing having a wall defining a cavity;
fixed contacts in the cavity, the fixed contacts include an input contact, a first output contact, and a second output contact;
a relay actuator in the cavity, the relay actuator including a plunger movable in a linear actuation direction between a retracted position and an advanced position;
a movable contact coupled to the plunger and movable with the plunger between a first mated position corresponding to the retracted position and a second mated position corresponding to the advanced position, the movable contact having a first contact portion, a second contact portion, and a third contact portion, the first contact portion being electrically connected to the first output contact in the first mated position, the second contact portion being electrically connected to the second output contact in the second mated position, the third contact portion being electrically connected to the input contact in both the first mated position and the second mated position.

15. The relay of claim 14, wherein the input contact and the first output contact create a first circuit in the retracted position and wherein the input contact and the second output contact create a second circuit in the advanced position.

16. The relay of claim 14, wherein the movable contact includes a flex member connected to the input contact, the flex member being flexible to move with the movable contact between the first mated position and the second mated position.

17. The relay of claim 14, wherein the plunger is moved vertically in the linear actuation direction.

18. The relay of claim 14, wherein the movable contact includes a contact plate extending between a first end and a second end, the movable contact including a first contact tab at the first end configured to engage the first output contact in the first mated position, the movable contact including a second contact tab at the second end configured to engage the second output contact in the second mated position.

19. The relay of claim 18, wherein the first contact tab is upward facing and the second contact tab is downward facing.

20. The relay of claim 18, wherein the first output contact is located above the contact plate and the second output contact is located below the contact plate, the movable contact movable vertically between the first mated position and the second mated position to interface with the first output contact and the second output contact, respectively.

21. The relay of claim 18, wherein the movable contact includes a flex member coupled to a central portion of the contact plate, the flex member being flexible to move with the contact plate as the contact plate is moved between the first and second mated positions.

22. The relay of claim 18, wherein the movable contact includes a first backup blade coupled to the contact plate and extending toward the first end to support the first end, the movable contact including a second backup blade coupled to the contact plate and extending toward the second end to support the second end.

23. The relay of claim 18, wherein the contact plate is oriented perpendicular to the linear actuation direction.

24. The relay of claim 14, wherein the housing includes a base, the fixed contacts extending from the base, the plunger and the movable contact being movable relative to the base in the linear actuation direction.

25. The relay of claim 24, wherein the first output contact has a first interface at a first distance from the base and the second output contact has a second interface at a second distance from the base, the second distance being different than the first distance.

26. The relay of claim 14, wherein the relay actuator includes a coil wound around a magnetic core, the coil being energized to move from the retracted position to the advanced position.

27. A relay comprising:
a housing having a wall defining a cavity, the housing extending between a first side and a second side;
right side fixed contacts in the cavity proximate to the right side, the right side fixed contacts include a right side input contact, a first right side output contact, and a second right side output contact;
left side fixed contacts in the cavity proximate to the left side, the left side fixed contacts include a left side input contact, a first left side output contact, and a second left side output contact;
a relay actuator in the cavity, the relay actuator including a plunger movable in a linear actuation direction between a retracted position and an advanced position;
a movable contact assembly coupled to the plunger and movable with the plunger between a first mated position corresponding to the retracted position and a second mated position corresponding to the advanced position, the movable contact assembly including a contact holder having a base coupled to the plunger, a right side mounting arm at a right side of the contact holder, and a left side mounting arm at a left side of the contact holder, the movable contact assembly including a right side movable contact coupled to the right side mounting arm and a left side movable contact coupled to the left side mounting arm;
wherein the right side movable contact is electrically connected to the right side input contact in both the first mated position and the second mated position, the right side movable contact being electrically connected to the first right side output contact and being disconnected from the second right side output contact in the first mated position, the right side movable contact being electrically connected to the second right side output contact and being disconnected from the first right side output contact in the second mated position; and
wherein the left side movable contact is electrically connected to the left side input contact in both the first mated position and the second mated position, the left side movable contact being electrically connected to the first left side output contact and being disconnected from the second left side output contact in the first mated position, the left side movable contact being electrically connected to the second left side output contact and being disconnected from the first left side output contact in the second mated position.
